(19) United States
(12) Patent Application Publication
(10) Pub. No.: US 2017/0098380 A1
(43) Pub. Date: Apr. 6, 2017

(54) SYSTEM AND METHOD FOR PROVIDING CUSTOMIZED CONTENT

(71) Applicant: D2L CORPORATION, Kitchener (CA)

(72) Inventors: Sebastian MIHAI, Kitchener (CA); Philip BROWN, Kitchener (CA); Marilyn POWERS, Kitchener (CA)

(21) Appl. No.: 14/874,823

(22) Filed: Oct. 5, 2015

(51) Int. Cl. G09B 7/00; G09B 5/02

(52) U.S. Cl. CPC G09B 7/00; G09B 5/02

(57) ABSTRACT

A system and method for providing customized content to a user is provided. The method includes: determining a plurality of learning objectives related to the course; assigning weights to the plurality of learning objectives; determining capability information for the user; determining a focus weight for each of the plurality of learning objectives for the user; and selecting content for the user based on the focus weight. The system includes: a learning objective engine configured to determine a plurality of learning objectives related to the course and assign weights to the plurality of learning objectives; a capability weight module configured to determine capability information for the user; a focus weight module configured to determine a focus weight for each of the plurality of learning objectives for the user; and a content amalgamation module configured to select content for the user based on the focus weight.

### FIELD

The present disclosure relates generally to providing customized content. More particularly, the present disclosure relates to a system and method for providing customized educational content.

### BACKGROUND

Learning and training courses, for examples, classes, seminars, workshops, or the like, often have explicit or implicit learning objectives. These learning objectives are areas or goals a student of the course is intended to achieve or obtain as a part of the completion of the course. Further, an institution, such as a school, college, university, business, or the like, may also have higher level learning objectives that may be broken down more succinctly or in more detail in view of the programs and courses offered by the institution.

Having defined learning objectives is generally considered to be beneficial to students and instructors in determining progress in a course or at an institution. If the student has achieved the learning objectives the instructor can be confident that the student has learned the material from the course. As courses frequently have a plurality of learning objectives, a student may excel at some of the learning objectives yet have deficits in other learning objectives. It may be difficult for the student to determine where the deficits are with respect to the learning objectives and what content the student should focus on to improve the deficits. An instructor can often be too busy to work with each student individually to assist the student in determining deficits and content.

It is, therefore, desirable to provide an improved method and system for providing customized content and, in particular, customized educational content.

The above information is presented as background only to assist with an understanding of the present disclosure. No determination has been made, and no assertion is made, as to whether any of the above might be applicable as prior art with regard to the present disclosure.

### SUMMARY

In a first aspect, the present disclosure provides a method for providing customized content for a user including: determining a plurality of learning objectives related to the course; assigning weights to the plurality of learning objectives; determining capability information for the user; determining a focus weight for each of the plurality of learning objectives for the user; and selecting content for the user based on the focus weight.

In a particular case, the method further includes: determining a context associated with the course; and selecting content for the user based on the context.

In another particular case, determining of the focus weight for each of the plurality of learning objectives includes: determining an assessment weight for each of the plurality of learning objectives; determining a capability weight for the user for each of the plurality of learning objectives based on the capability information; and combining the assessment weight and capability weight to determine the focus weight.

In yet another particular case, the capability weight is based on previous assessments of the user for each of the plurality of learning objectives.

In still another particular case, the assessment weight is based on a point value assigned to each learning objective on an upcoming assessment in the course.

In still yet another particular case, selecting content for the user includes: selecting a plurality of content items for each of the learning objectives based on the focus weight.

In a particular case, selecting content for the user includes: selecting content for a practice exam related to the course.

In another particular case, selecting content for the practice exam includes: determining a total point value for an upcoming exam within the course; determining a point value for each of the learning objectives associated with the upcoming exam based on the total point value; determining the content for the practice exam based on the point value for each of the learning objectives and the focus weight of the user for each of the learning objectives; and amalgamating the content to form a practice exam.

In yet another particular case, the method further includes: determining a new focus weight for each of the plurality of learning objective for the user after the user has completed the content; and ranking the content based on a change between the new focus weight and the focus weight prior to completing the content.

In still another particular case, the method further includes: determining a ranking of the selected content for the user; and selecting the content based on the ranking of the content.

In still yet another particular case, the method further includes: determining user attributes for the user; and selecting the content based on the user attributes.

In another particular case, the user attributes are selected from the group comprising: user's grade point average (GPA), user's previous courses, user's preferred study techniques, and user's background.

In still another particular case, the content is selected from a plurality of document repositories associated with a plurality of learning institutions.

In another aspect, there is provided a system for providing customized content for a user including: a learning objective engine configured to determine a plurality of learning objectives related to the course and assign weights to the plurality of learning objectives; a capability weight module configured to determine capability information for the user; a focus weight module configured to determine a focus weight for each of the plurality of learning objectives for the user; and a content amalgamation module configured to select content for the user based on the focus weight.

In a particular case, the learning objective engine of the system is further configured to determine an assessment weight for each of the plurality of learning objectives; the capability weight module is further configured to determine a capability weight for the user for each of the plurality of learning objectives based on the capability information; and the focus weight module is further configured to combine the assessment weight and capability weight to determine the focus weight.

In another particular case, the content amalgamation module is further configured to select a plurality of questions for each of the learning objectives based on the focus weight.

In yet another particular case, the content amalgamation module is further configured to select content for a practice exam related to the course.

In still yet another particular case, selecting content for the practice exam includes: the learning objective module is configured to determine a total point value for an upcoming exam within the course and determine a point value for each of the learning objectives associated with the upcoming exam based on the total point value; and the content amalgamation module is configured to determine the content for the practice exam based on the point value for each of the learning objectives and the focus weight of the user for each of the learning objectives and amalgamate the content to form a practice exam.

In still another particular case, the system includes a ranking module configured to determine a ranking of the selected content for the user and the content amalgamation module is configured to select the content based on the ranking of the content.

In yet another particular case, the capability weight module is further configured to determine user attributes for the user and the content amalgamation module is configured to select the content based on the user attributes.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is an example environment for a system for providing customized content according to an embodiment;

FIG. 2 is a block diagram of a system for providing customized content according to an embodiment;

FIG. 3 is a flowchart of a method for providing customized content according to an embodiment;

FIG. 4 is a flowchart of a method for creating a customized examination according to an embodiment;

FIG. 5 illustrates example learning objectives associated with a course;

FIG. 6A illustrates grades obtained by a student throughout the semester in relation to the course of FIG. 5;

FIG. 6B illustrates the grades of FIG. 6A converted to weights;

FIG. 7 illustrates the weights of the learning objectives for an upcoming exam for the course of FIG. 5;

FIG. 8 illustrates focus weight for a student given the weights illustrated in FIG. 7;

FIG. 9 illustrates normalized focus weights for the weights shown in FIG. 8; and

FIG. 10 illustrates a method for ranking content according to an embodiment.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides a method and system for providing customized content. The focus of the disclosure is on providing customized content in an educational environment but one of skill in the art will understand that embodiments of the system and method described herein may also be used in other environments including training, sports, or other areas with objectives and evaluations. Although the examples detailed herein relate to educational institutions, it will be understood that the system and method may be used for any courses, training, seminars, or the like where there is at least one learning objective and one or more assessments. For example, on the job training, self study online courses, or the like may also benefit from embodiments of the system and method detailed herein.

In one embodiment, the system is configured to determine a plurality of learning objectives for a course or an upcoming assessment, for example, an upcoming assignment, test, exam, paper, or the like. The system is also configured to determine a weight for each learning objective. The system then tracks a user's capability information. Capability information is information that may indicate a student's or user's abilities with regard to a course, learning objective type or the like. Capability information may include results in course material, for example, assignments, exercises, exams, midterms, and the like, or evaluations from instructors or the like. The capability information is used to determine a capability weight for the user. The system determines a focus weight for each learning objective based on the capability weight and the assessment weight. The system then determines a context in relation to the course or assessment. The system retrieves content items within the context based on the focus weight for each learning objective for the user, which is intended to create customized content for that user. Content items may be, for example, questions, business cases, training scenarios, example problems, material to review, or the like.

In some cases, embodiments of the method and system for providing customized content may further provide analytic and reporting capabilities. In an example, the system and method may be operatively connected to a learning management system (LMS) within an educational institution and may be used to track a student's progress or a plurality of students' progress in relation to at least one learning objective. In another example, the system and method may be configured or used to determine one or more correlations between the content provided and student improvement towards achieving at least one learning objective.

Embodiments of the system and method detailed herein are intended to provide more personalized content to a student. In particular, embodiments of the system and method described herein are intended to determine, for individual students, which learning objectives or study areas need more improvement and which learning objectives or study areas have had better results and focus the content to the student's areas of weakness. In a particular example, the content delivered to the user may be a practice exam with specific focus on learning objectives or study areas of concern for that user.

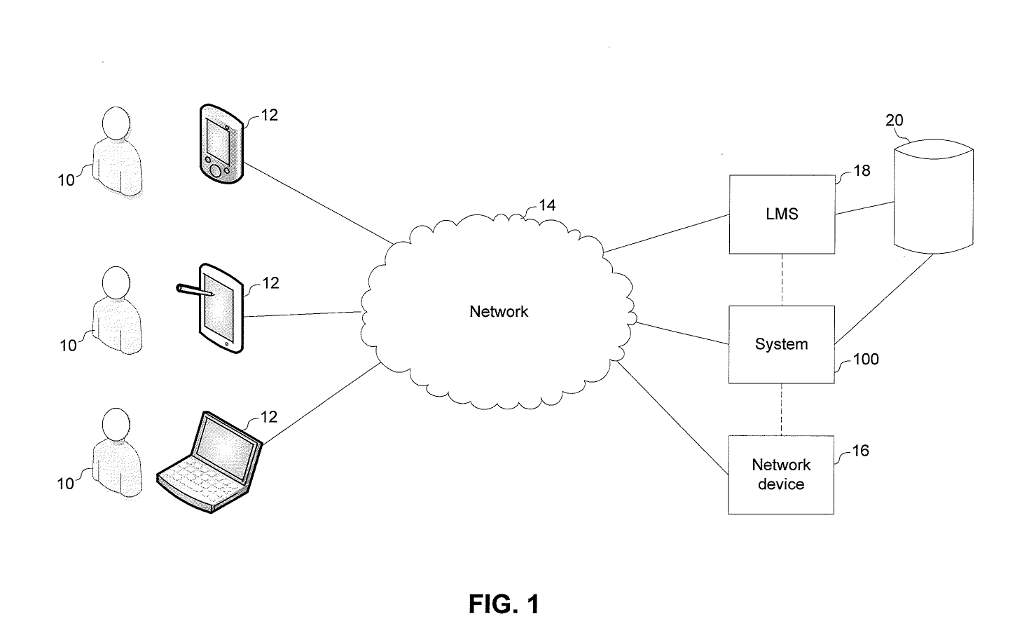

FIG. 1 illustrates an example environment for an embodiment of a system 100 for providing customized content. In this embodiment, users 10, for example, students, employees, instructors, administrators, or the like, use a variety of user devices 12, for example, laptop computers, desktop computers, tablets, mobile phones, smartphones, televisions, or the like, for accessing a network 14, for example, the Internet, a Local Area Network (LAN), a Virtual Local Area Network (VLAN), a Wide Area Network (WAN), a Virtual Private Network (VPN), or the like.

Users 10 access electronic content, for example, an institution's Intranet, a course website, a document repository, or the like, from one or more network devices 16 via a network 14. Users 10 may also access content from a learning management system 18, for example, course material such as class specific web sites, assignments, practice exams, practice questions, institution related material, student related material, or the like.

The system 100 may be partly incorporated in a network device 16 or a learning management system 18 or may be configured using a stand-alone network device operatively connected to one or more network devices or learning management systems. The operative connection may be via a direct connection (shown in dotted lines) or via the network 14. The system 100 may also be operatively connected to at least one external database 20. The system 100 may query the database 20 and may retrieve electronic content from the database 20.

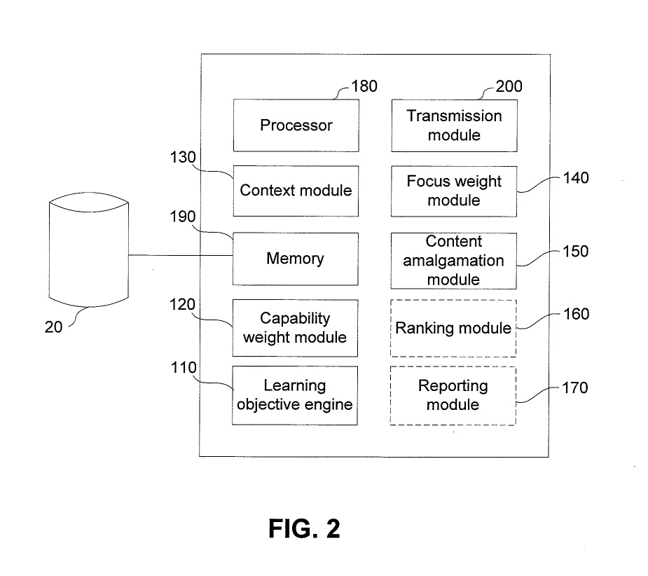

FIG. 2 illustrates the system 100 for providing customized content according to an embodiment. The system 100 includes a learning objective engine 110, a capability weight module 120, a context module 130, a focus weight module 140, a content amalgamation module 150. In some cases, the system 100 may further include a ranking module 160, and a reporting module 170. The system 100 also includes a processor 180, a memory module 190, and a transmission module 200.

The learning objective engine 110 is configured to determine learning objectives associated with a course or upcoming assessment of a course. In some cases, the learning objective engine 110 may review the questions or problems on an upcoming assessment and categorize the questions into a plurality of learning objectives. In other cases, the learning objective engine 110 may retrieve predetermined learning objectives associated with the course, for example from a database or the like. In still other cases, the learning objectives may be manually entered by a user, for example, an instructor, an administrator, a course designer or the like (sometimes referred to as a “super-user”).

The learning objective engine 110 retrieves an overall weight of the assessment and determines the weight of each learning objective based on the overall weight of the assessment. In some cases, the system may determine the weights automatically and align the weights with the learning objectives based on, for example, key words aligning the problems of the assessment with the learning objectives. In other cases, the super-user may manually enter the weight of each learning objective for the upcoming assessment. In still other cases, the learning objective engine 110 may determine the weight for each learning objective and display the correlated weights and learning objectives to the super-user. The super-user may then confirm, override or otherwise amend the weights associated with any of the learning objectives.

The capability weight module 120 is configured to determine a user capability weight for each learning objective of the plurality of learning objectives within the assessment. The capability weight module 120 is configured to retrieve capability information, for example, user's performance on previous assessments to determine the user capability with regard to each learning objective. In some cases, the capability weight module 120 may retrieve user performance from the memory module 190 of the system or from an external database 20. In other cases, the capability weight module 120 may include a database to store capability information, for example, user performance and results on assessments from other courses, studies, or the like.

The context module 130 is configured to determine a context related to the learning objectives and the course and/or upcoming assessment. A context may be a single course, or multiple courses. In an example, the determined context may be every occurrence of a particular course taught over a particular time frame, for example, the last year, 2 years, 5 years, 10 years, or the like. In another example, the determined context may be broader and include similar courses taught at other institutions or may be narrower and be restricted to the same course taught by the same professor. In some cases, the context may be determined automatically by, for example, predetermined rules. In other cases, the context may be manually selected by the super-user, by choosing specific courses to include within the context. In still other cases, the context may be determined automatically with the ability for the super-user to confirm, override or otherwise amend the context selection.

The focus weight module 140 is configured to determine a focus weight associated with each of the plurality of learning objectives based on the assessment weight of each of the plurality of learning objectives and the capability weight of each of the plurality of learning objectives for a user. Although a plurality of users accessing the system 100 may have the same upcoming assessment, the focus weight for each learning objective may vary for each user depending on each user's determined capability for a particular learning objective.

The content amalgamation module 150 is configured to retrieve content items within the determined context based on the focus weight for the user accessing the system. In some cases, the content amalgamation module 150 may provide the user with a suggested sequence of course content which is intended to increase the student's perceived deficit in the assessed learning objectives. In other cases, the content amalgamation module 150 may provide the user with a practice exam customized for that user. The content amalgamation module 150 may retrieve content, for example, questions, problems, assignments, exams, or the like, from the memory module 190 and/or other external memory banks, for example, the at least one database 20.

The ranking module 160 is configured to rank the content based on user improvement. Through tracking user progress with respect to learning objectives after completion of particular content items, for example, particular questions, business cases, training scenarios, example problems, papers, articles, or the like, the content may be ranked based on its effectiveness of improving the users' capability with respect to the learning objective. Based on the ranking, it is intended that the system 100 may provide users with content that has been shown to be more effective at improving users' capability with respect to each learning objective.

The reporting module 170 is configured to retrieve data from the memory module 190 or from external sources, for example, the at least one external database 20, and report data in relation to, for example, the content, capability weights, assessment weights, and the like. In some cases, the reporting module 170 may report an individual user's progress in relation to his capabilities with respect to various learning objectives. In other cases, the reporting module 170 may report capability weights of a plurality of users, for example, all the students in a course, the students in a particular section of the course, or the like, to the super-user.

In an example, the capability weight of a plurality of students within a course may be amalgamated, for example, to be averaged, to be summed, to find a median weight, or the like, for the super-user to ascertain the overall understanding of a learning objective for the plurality of students. In some cases, the reporting module 170 may detect outliers, for example, students who are vastly underperforming in a particular learning objective, and the reporting module may flag or otherwise notify the super-user of the outliers.

The system 100 further includes the processor 180. The processor 180 is configured to execute instructions from the other modules of the system 100. In some cases, the processor 180 may be a central processing unit. In other cases, each module may be operatively connected to a separate processor. The system further includes a memory module 190, for example a database, random access memory, read only memory, or the like.

The transmission module 200 is configured to receive and transmit data to and from the network 14, the network device 16, the learning management system 18 or the like. The transmission module 200 may be, for example, a communication module configured to communicate between another device and/or the network 14. The transmission module 200 may receive or intercept a request from a user, via the network, to access the system 100. In some cases, the user request may be directed to the system. In other cases, the transmission module 200 may intercept a request directed to a learning management system 18 or other network device 16.

It will be understood that in some cases, the system 100 may be a distributed system wherein the modules may be operatively connected but may be hosted over a plurality of network devices.

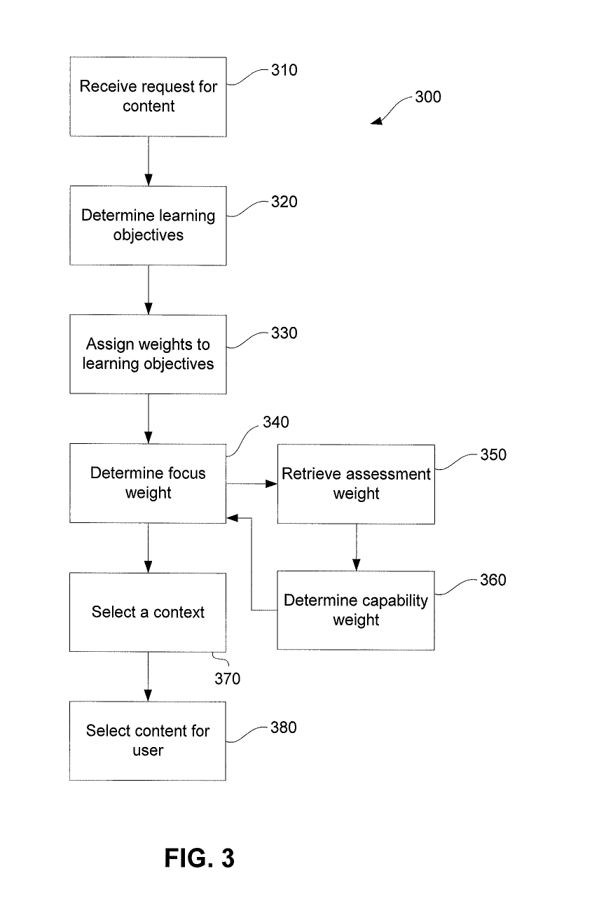

FIG. 3 illustrates an embodiment of a method 300 for providing customized content. At 310, the transmission module 200 receives a request for content. In an example, the request may be received when a user, for example a student, has logged into a learning management system 18 and accesses, for example, a link, a button, hyperlinked content, or the like, to retrieve study material. The request may be associated with for example, a course, an upcoming assessment, or the like.

The learning objective engine 110 receives the request from the transmission module 200. The learning objective engine 110 retrieves any upcoming assessment related to the request and determines the learning objectives included on the assessment, at 320 by, for example, matching key words within a problem or question of the assessment with key words of the learning objective. The learning objective engine 110 may also determine the learning objectives of the course based on, for example, learning objectives that were assessed in previous assessments or retrieve the learning objectives that may have previously determined or previously entered by a super-user.

At 330, a weight is obtained for each learning objective included on the assessment. In some cases, weights may be retrieved by the learning objective engine 110 if the weight has been previously assigned or amended by the super-user. In other cases, the weights may be ascertained by the learning objective engine 110 by determining the point values assigned to each question out of the total value of the assessment, or from determining point values assigned on previous assessments stored in the memory module 190 or external database 20.

At 340, a focus weight is determined for the student by the focus weight module 140. Generally, the focus weight is based on a determination of assessment weight 350 and a determination of capability weight 360 as described below. In some cases, the focus weight may be assigned or modified by a super-user, for example a teacher. In an example, the teacher may know that the capability weight for a particular student is skewed, for example the student received additional help on the assignment and the mark received was based partly on this additional help. The capability weight may illustrate a higher level on understanding for the student then the student has. The teacher may wish to amend the focus weight in order to more accurately reflect the learning objectives on which the student should focus.

At 350, the assessment weight for each learning objective determined by the learning objective engine 110 is retrieved. This assessment weight is intended to provide a guide as to how critical or important a certain learning objective is on an upcoming assessment.

At 360, the capability weight for the student is determined by the capability weight module 120. The capability weight may be obtained from the capability information for the student, by determining the grade the student received on the activity or questions associated with the learning objective throughout the assessment time, for example the year, previous years, the term, or the like. In an example, the grade, G, may be normalized between 0 and 1 with 1 corresponding to a perfect grade. The capability weight, CW, may then be determined as CW=1−G. The capability weight is intended to represent a level of competence of a particular learning objective for the student via work previously completed by the student. The lower the capability weight the better the student's performance has been in that learning objective, with a weight of near zero being given to a student that has received near perfect grades on all the activities associated with the learning objective. A higher capability weight closer to 1 corresponds to lower results and achievements associated with the learning objective. Although illustrated as being completed after determining assessment weight, the capability weight may be determined prior to or together with the assessment weight.

The focus weight, FW, is determined by combining the capability weight, CW, with the assessment weight, AW. In an example, the focus weight may be a mathematical function of the capability weight CW and the assessment weight AW, which in a simple case might be the product of the capability weight and the assessment weight, FW=CW×AW. The focus weight may also be normalized if necessary. A low capability rate will be associated with a lower focus weight, while a higher capability weight will be associated with a higher focus weight. The focus weight is intended to represent how much the student should focus on each learning objective.

At 370, a context is selected by the context module 130. In some cases, the context may have been predetermined by the context module 130 or may have been previously entered by the super-user. In other cases, the context module 130 may determine the context automatically, for example, by retrieving similar course information over a predetermined time period, for example, 2 years, 5 years, 10 years, or the like.

At 380, customized content is selected for the student by the content amalgamation module 150. The content amalgamation module 150 retrieves previously stored content based on the context and the focus weight of each learning objective. The content may then be transmitted to the user device 12 via the transmission module 190. In some cases, the content may be shown in a sequence ordered by focus weight.

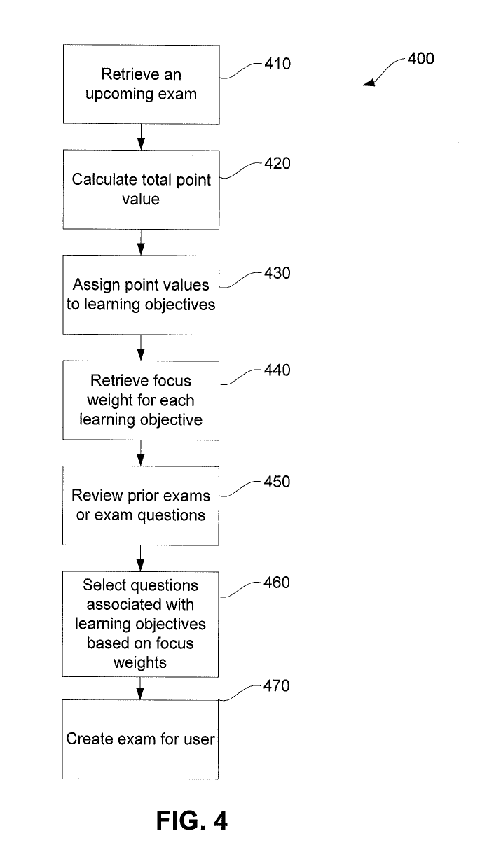

FIG. 4 illustrates an embodiment of a method 400 for creating a customized evaluation, such as an exam or test, for a user, for example a student. In a specific example, the user may wish to study for an upcoming exam and the system 100 may customize a practice exam for the user.

At 410, the system 100 retrieves an upcoming exam entered by an instructor for a course requested by the user. At 420, the learning objective engine 110 calculates the total point value of the upcoming exam.

At 430, the learning objective engine 110 determines the learning objectives on the upcoming exam and establishes point values for each of the learning objectives included within the upcoming exam. The point values for each of the learning objectives is based on the total point value of the upcoming exam determined at 420. In some cases, the learning objective engine 110 may associate the point values to the learning objectives based on key words within the problems or questions of the exam.

At 440, the focus weight module 140 determines the focus weight for the user associated with each learning objective. The focus weight may be retrieved from a previously calculated focus weight of the student, or may be calculated by the focus weight module 140.

At 450, the content amalgamation module 150 retrieves prior exams or exam questions. In some cases, the content amalgamation module 150 may review prior exams or exam questions from within the institution administering the upcoming exam. In other cases, the content amalgamation module may review questions from similar courses in various institutions to allow for a greater number of available questions.

At 460, the content amalgamation module 150 selects content items, for example, problems, questions, or the like, associated with the learning objectives and focus weight.

At 470, the system 100 provides the user with a customized practice exam.

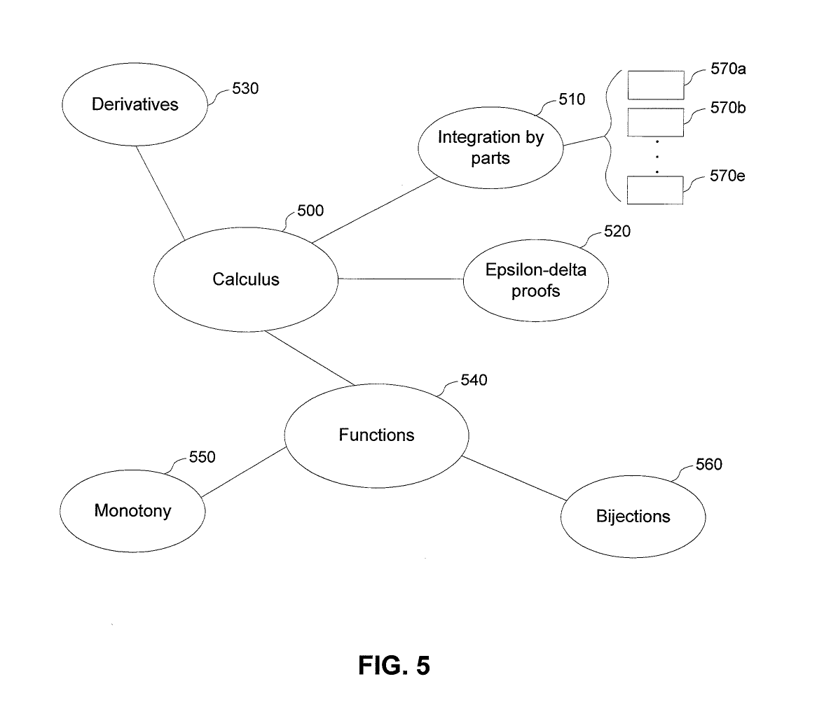

In a specific example, the system 100 may be used in reference to a mathematics course. The learning objectives for the course are determined, as illustrated in FIG. 5. In FIG. 5, each node represents a learning objective, for example, Calculus 500, (or in some cases sub-learning objectives, for example, Functions 540, Derivatives 530, Integration by Parts 510, Epsilon-delta proofs 520, Bijections 560, Monotony 550). In an example, the overall learning objective for a mathematics course may be Calculus 500 and the course may include various sub-elements that form the learning objectives required to complete the Calculus course 500. In some cases, the overall learning objective may include stand alone material a user may review, or the overall learning objective may be completed once the learning objective in the sub-nodes are completed.

Each node/learning objective is associated with one or more pieces of content, for example, activities, assignments, tests, or the like, in the course. For example, derivatives may be mapped to two quizzes, integration by parts may be mapped to five homework assignments 570a to 570e, and other objectives may be similarly mapped. In some cases, system 100 may determine the learning objectives for the course from reviewing the one or more pieces of content and aligning key words and content items with various learning objectives. In other cases, the system may determine the learning objectives for the course from retrieving previously stored learning objectives associated with the course or by providing a super user with an ability to enter or amend learning objectives associated with the course.

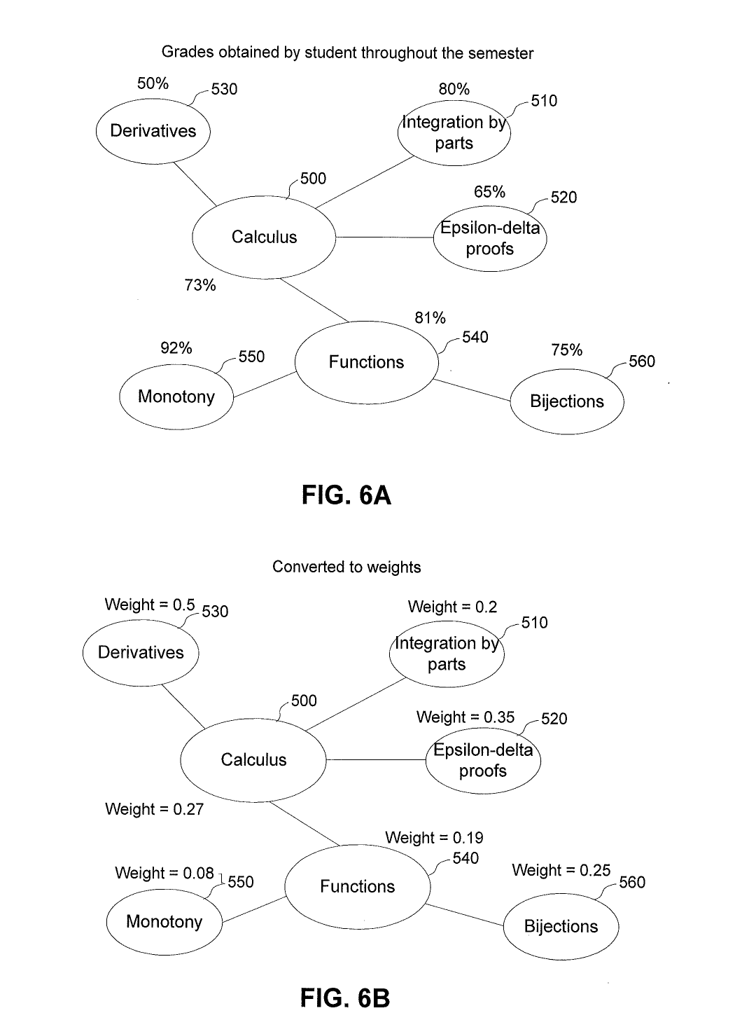

A weight for each learning objective of each student in the mathematics course is determined. For an example student, the outcome of previous assessments is obtained for each completed activity. Each learning objective may be assigned a grade, G, calculated as a summation or average of the percentage grades obtained by the student in each learning objective as illustrated in FIG. 6A.

Capability weights, CW, may be determined from the grades obtained, G, by, for example CW=1−G (where a grade of 100% or perfect would result in a 0 weight), as shown in FIG. 6B.

In some cases, the capability weight for a specific student, for a specific learning objective in a course may be a normalized average of grades obtained on assessment questions aligned to the learning objective, within the last K semesters or time periods, where K is a predetermined integer, for example, 2, 5, 10, or the like.

In other cases, the capability weight may be a combination of the above calculations and a weighted average of capability weights of directly connected learning objectives. Learning objectives, as illustrated in FIG. 6A, may be directly connected to similar learning objectives, for example a parent and child relationship, sibling relationship, or the like, and the capability weights may be a combination of the capability weights of the neighboring nodes. The contribution of the weight of a neighboring capability weight may be configurable by an instructor or other super-user.

In still other cases, the contribution of the weight of neighboring capability weights may be predetermined by the system 100. For example, any neighboring learning objective which has a capability weight above a predetermined threshold, for example 0.5, 0.7, 0.8 or the like, contributes a specific amount, for example, 0.025, 0.05, 0.1, or the like, to the capability weight of the specific learning objective.

The system 100 is also intended to address a situation where the student has received a perfect score for a learning objective because, in order to refresh the students knowledge prior to an exam, study time is still recommended for even a known or understood learning objective. In an example, ranges could be defined for example, 0-20%, 20-40%, to 80-100%, and each range could be assigned a weight value to ensure a non-zero weight even for a learning objective in which the student has received perfect scores. The ranges may be configurable or may be predetermined.

In another example, the weight values may be fit to a bell curve so that very low scores for certain learning objectives during the term get a low weight due to the expectation that the student cannot gain enough competence in that area prior to the upcoming assessment. The bell curve may be done relative to the student's other scores, for example, the system may not consider a grade of 20% to be extremely low for a student with an average of 37% but may consider the grade of 20% extremely low for a student with an average of 75%.

In a specific example, if, for a given student, one or more learning objectives do not have a grade for the student, the capability weights may be adjusted upwards to compensate for the absence of the student's performance data for that learning objective.

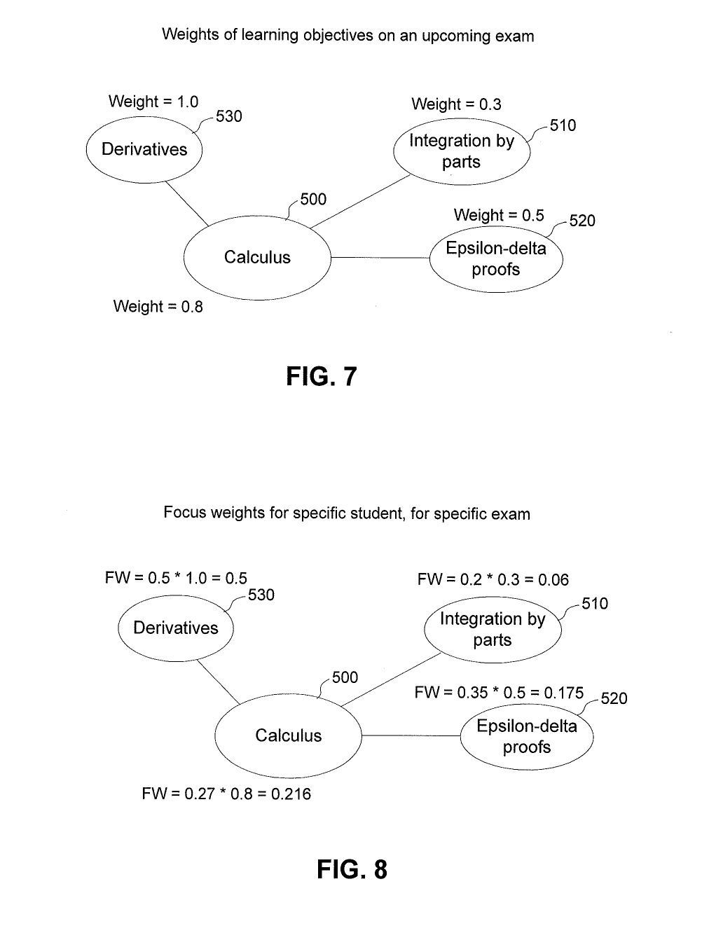

Assessment weights are also determined for the upcoming assessment. The learning objectives for the upcoming assessment may be a subset of the learning objectives for the course. The learning objectives may be determined automatically by the learning objective engine 110 or may be entered manually by the instructor of the mathematics course. If determined automatically, the assessment weights for each of the learning objectives may be determined automatically based on the total point value of the upcoming assessment and the point value of each question or problem containing material related to the particular learning objective. In a particular case, the assessment weights may be automatically determined by the system 100 and updated or modified by the instructor of the class. FIG. 7 illustrates one example of assessment weights of learning objectives on an upcoming assessment. In this example, the assessment weights, AW, may have a range from 0 to 1 wherein a value of 1 would be considered the most important and 0 would be considered not important or not appearing on the upcoming assessment. Other ranges for assessment weights may be used.

The system 100 determines a focus weight for each learning objective for each student. The focus weight may, for example, be calculated as FW=CW×AW. In some cases, if ranges other than a range of 0 to 1 are used, the capability weight CW and assessment weight AW may be normalized prior to determining the focus weight FW. FIG. 8 illustrates focus weights for the specific student for the upcoming exam in the example of the mathematics course. For each of the learning objectives, a focus weight is calculated for the upcoming assessment.

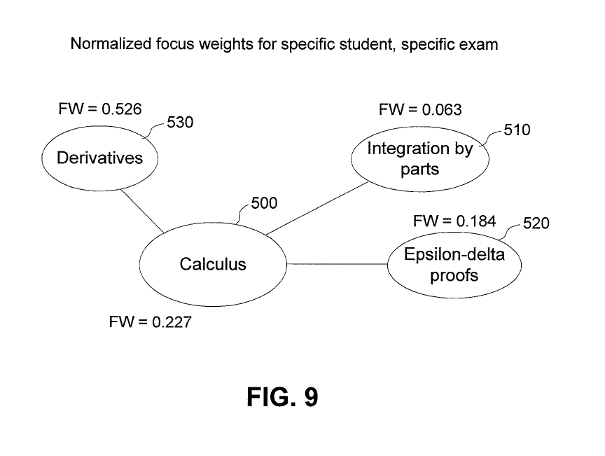

The focus weights can be normalized as shown in FIG. 9. The focus weights can further be sorted in descending order such that FW, would be considered the focus weight with the highest value and thus is intended to represent the learning objective the student should focus more on when studying than a FW with a lower value.

A context is selected with respect to the upcoming assessment. The context could be a single course, multiple courses and may be predetermined by the system or manually entered or modified by the instructor. In this example, the instructor may want the context to be calculus courses taught by this institution within the last 5 years. The context may include, for example, courses in the student's program of study, the same department as the course with the upcoming assessment, similar courses taught in other institutions, or the like.

The content items are selected to provide customized content for the student. In this example, the student may receive 8 problems to complete, with 3 of the problems related to derivatives, the learning objective with the highest focus weight, followed by 2 questions related to calculus, the next highest focus weight, followed by a single question for each of integration by parts and epsilon-delta proofs. The number of questions per learning objective may vary depending on, for example, pre-determined parameters, student request of total number of questions desired, available time determined by the student, available content items, by the system, or the like.

In a specific case, the content may be delivered as a practice examination or test. The system 100 may be configured to retrieve the upcoming exam stored in the memory module 200 or external database 20. The system 100 is intended to keep the content of the exam hidden from any student accessing the system. The total point value, TPV, may be obtained by summing the point value of all the questions on the upcoming exam. Point values, PVᵢ, are further assigned to each learning objective from the plurality of learning objectives (i) within the upcoming exam, such that the point value for each learning objective is the focus weight for that learning objective (i) multiplied by the total point value: PVᵢ=TPV×FWᵢ. This will yield point values which represent how many points of the customized practice exam should be allocated to each of the learning objectives associated to the questions in the upcoming exam.

The content amalgamation module 150 may retrieve prior exams and/or prior practice exams within a context to create an exam pool. For each learning objective, the content amalgamation module 150 may select questions from the exam pool such that the questions are associated with each of the learning objectives and add up to the corresponding point value, plus or minus a predetermined margin. The predetermined margin may be based on, for example, the size of the exam pool. In some cases, the questions may be randomly selected from the exam pool. The content amalgamation module 150 creates a practice exam from the selected questions which is intended to target areas of weakness for the student based on the learning objectives within the upcoming exam.

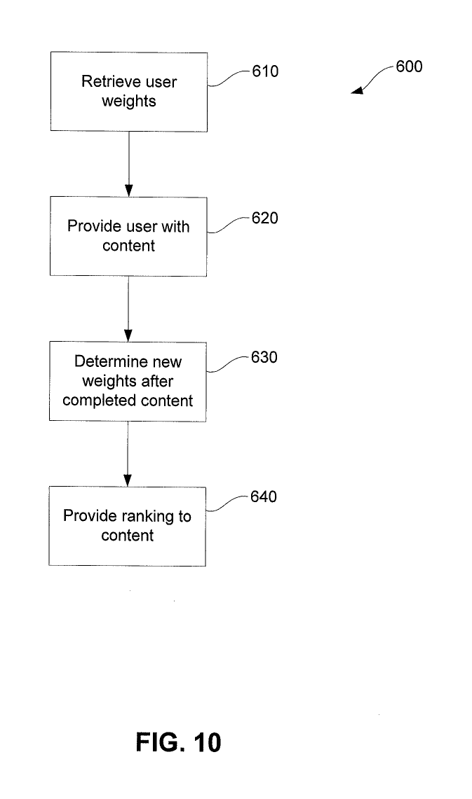

FIG. 10 illustrates a flow chart for an embodiment of a method 600 for ranking content that may be used with the embodiments of the system and method described herein. A content item that is distributed to the users may be reviewed and ranked depending on the improvements made in the learning objective after reviewing the specific content item in relation to improvements made after reviewing other content items related to the same learning objective. It is intended that by providing rankings to the content items, content that has demonstrated greater improvements for users may be selected more frequently when developing customized content for other students or users.

At 610, capability weights are retrieved for a user of the system. At 620, the user is provided with customized content by the system based on the user's capability weights as described above.

At 630, capability weights for the user are re-calculated based on the results of the user completing the provided customized content. Based on the original and re-calculated capability weights, changes in the capability weights for each of the learning objectives are calculated. The change in the capability weight can be considered an indicator of the effectiveness of the provided content in increasing capability. It is intended that the ranking module 160 may provide each content item for example, each question, problem, or the like, with a rank, at 640.

In some cases, the changes in capability weights may be amalgamated over a plurality of users provided with the same content. Amalgamating the changes in capability weights may provide a better idea of an appropriate rank to the content item.

When creating customized content, the content amalgamation module 150 may retrieve and review the rank of the content and may select content with a higher ranking prior to selecting content with a lower ranking. It is intended that, by providing higher ranking content to the user, the user may have greater improvement than if randomly selecting content. In some cases, if it has been noted that questions receive a zero or null ranking, as no improvement has been noted by users who have completed the content, the questions may be eliminated from the content storage, or may no longer be retrieved by the content amalgamation module 150.

In a specific example, the system 100 may be used for on the job training. Learning objectives may be associated with various aspects of job training and customized content may be provided to the users for use in preparing for assessments related to job training.

In another specific example, the system 100 may be used in relation to professional exam preparation. The professional exam may be associated with various learning objectives required to receive a professional designation. Users may wish to focus on content where their capabilities have been shown to be lower than in areas where their capabilities are higher.

In some cases, the reporting module 170 may be used to provide cumulative reports over a plurality of users to a super-user, for example, an instructor. In a specific example, the instructor may decide to provide students with a practice session prior to an upcoming assessment, for example, an exam. The instructor may select a report to determine the average capability weight per learning objective in order to tailor the practice session to areas with the lowest average capability weight.

In another example, the reporting module 170 may be used by a super-user to track trends over a period of time, for example 1 year, 2, years, 5 years or 10 years. The capabilities of all students within a course over a period of time may be reviewed to determine trend with respect to students meeting learning objectives. For example, it may be determined that students have been improving in certain learning objectives year over year, yet declining in other learning objectives. It is intended, that with the results, instructors or faculty may amend the focus in the various learning objectives to better adapt to these trends.

The system 100 may be beneficial in flagging students that may require additional help in a course or subject. In particular, in faculties where there has been an increasing number of students to instructors, instructors may not be able to provide the guidance to students that they have previously been able to provide. Instructors may not have detailed information about particular students, nor may not be able to attribute grades to various students, especially in courses where the lectures may consist of hundreds of students. In some cases, the system 100 may flag students who have a capability weight below a predetermined threshold weight, for example, a grade of 50%, an incomplete grade, or the like, and report the student to the instructor to allow the instructor to review the student assessments and provide additional help to flagged students.

In other cases, the system 100 may provide further guidance to a student who has a capability weight fall below a predetermined threshold weight. In a specific example, the system 100 may notify the student of a particular delinquency with respect to a learning objective. In other cases, the system 100 may automatically provide further content to a student if the student's capability weight has fallen below the predetermined threshold weight.

In still other cases, the system 100 may provide feedback to an instructor or other super-user with respect to students who have not accessed the system or have not made use of the content. In particular, the system 100 may determine whether a correlation exists between below average capability weights and students who are not accessing the customized content provided by the system.

In a specific example, the system 100 may be operatively connected to or have access to various publishing companies document repositories. The system 100 may align learning objectives with content from the document repositories. In addition to, or instead of, providing questions or problems in relation to specific learning objectives, the system 100 may direct the user of the system to publications where the user could further focus on a learning objective by reviewing material, such as, books, articles, newspapers, journals, or the like, that are aligned with the learning objective. It is intended that this may be beneficial in various areas, for example, medicine, law, or the like, where assessments may be based in part on external knowledge.

In an example embodiment the system 100 may be operatively connected to a plurality of learning management systems for a plurality of learning institutions. The system may be able to track and provide trends related to comparisons between the learning institutions. For example, a certain institution may have students with favourable capability weights in a particular learning objective while students in another institution have favourable capability weights in a different learning objective. The system 100 may be configured to determine which institutions appear to have favourable capabilities in which learning objectives and may provide customized content by combining content from the various institutions and retrieve questions or contents from the institution with the more favourable capability rating for the learning objective.

In a further example, the system 100 may customize the content based on the rank of the content and further based on user attributes, for example user's grade point average (GPA), user's previous courses, user's preferred study techniques, user's background, or the like. By categorizing users based on user attributes, the system 100 may determine that particular content provided better results for a specific user attribute while other content provided better results of other attributes. For example, students with a GPA of 3.0 may have shown improved capabilities associated with a specific set of content items while students with a 3.7 GPA may have had greater improvement with a different set of content items. By further categorizing and ranking the content items, it is intended that the student receive beneficial customized content for that student.

In another example, the system 100 may store manually amended assessment weights and track the amended weights per instructor or per super-user. If the system 100 determines that similar amendments have been made multiple times, the system 100 may suggest amendments to the assessment weights allowing the instructor to review the suggested amendments that are intended to parallel previous amendments made by the instructor. By reviewing trends for each instructor or super-user, it is intended that the system 100 reduce the amount of time the instructor spends manually amending the weights of assessments.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for providing customized content for a user comprising:
determining a plurality of learning objectives related to the course;
assigning weights to the plurality of learning objectives;
determining capability information for the user;
determining a focus weight for each of the plurality of learning objectives for the user; and
selecting content for the user based on the focus weight.

2. The method of claim 1 further comprising:
determining a context associated with the course; and
selecting content for the user based on the context.

3. The method of claim 1 wherein the determining of the focus weight for each of the plurality of learning objectives comprises:
determining an assessment weight for each of the plurality of learning objectives;
determining a capability weight for the user for each of the plurality of learning objectives based on the capability information; and
combining the assessment weight and capability weight to determine the focus weight.

4. The method of claim 3 wherein the capability weight is based on previous assessments of the user for each of the plurality of learning objectives.

5. The method of claim 3 wherein the assessment weight is based on a point value assigned to each learning objective on an upcoming assessment in the course.

6. The method of claim 1 wherein the selecting content for the user comprises: selecting a plurality of content items for each of the learning objectives based on the focus weight.

7. The method of claim 1 wherein the selecting content for the user comprises: selecting content for a practice exam related to the course.

8. The method of claim 7 wherein the selecting content for the practice exam comprises:
determining a total point value for an upcoming exam within the course;
determining a point value for each of the learning objectives associated with the upcoming exam based on the total point value;
determining the content for the practice exam based on the point value for each of the learning objectives and the focus weight of the user for each of the learning objectives; and
amalgamating the content to form a practice exam.

9. The method of claim 1 further comprising:
determining a new focus weight for each of the plurality of learning objective for the user after the user has completed the content; and
ranking the content based on a change between the new focus weight and the focus weight prior to completing the content.

10. The method of claim 1 further comprising:
determining a ranking of the selected content for the user; and
selecting the content based on the ranking of the content.

11. The method of claim 1 further comprising:
determining user attributes for the user; and
selecting the content based on the user attributes.

12. The method of claim 11 wherein the user attributes are selected from the group comprising: user's grade point average (GPA), user's previous courses, user's preferred study techniques, and user's background.

13. The method of claim 1 wherein the content is selected from a plurality of document repositories associated with a plurality of learning institutions.

14. A system for providing customized content for a user comprising:
a learning objective engine configured to determine a plurality of learning objectives related to the course and assign weights to the plurality of learning objectives;
a capability weight module configured to determine capability information for the user;
a focus weight module configured to determine a focus weight for each of the plurality of learning objectives for the user; and
a content amalgamation module configured to select content for the user based on the focus weight.

15. The system of claim 14 wherein:
the learning objective engine is further configured to determine an assessment weight for each of the plurality of learning objectives;
the capability weight module is further configured to determine a capability weight for the user for each of the plurality of learning objectives based on the capability information; and
the focus weight module is further configured to combine the assessment weight and capability weight to determine the focus weight.

16. The system of claim 14 wherein the content amalgamation module is further configured to select a plurality of questions for each of the learning objectives based on the focus weight.

17. The system of claim 14 wherein the content amalgamation module is further configured to select content for a practice exam related to the course.

18. The system of claim 17 wherein the selecting content for the practice exam comprises:
the learning objective module is configured to determine a total point value for an upcoming exam within the course and determine a point value for each of the learning objectives associated with the upcoming exam based on the total point value; and
the content amalgamation module is configured to determine the content for the practice exam based on the point value for each of the learning objectives and the focus weight of the user for each of the learning objectives and amalgamate the content to form a practice exam.

19. The system of claim 14 further comprising a ranking module configured to determine a ranking of the selected content for the user and the content amalgamation module is configured to select the content based on the ranking of the content.

20. The system of claim 14 wherein the capability weight module is further configured to determine user attributes for the user and the content amalgamation module is configured to select the content based on the user attributes.
